(19) United States
(12) Patent Application Publication
(10) Pub. No.: US 2018/0374417 A1
(43) Pub. Date: Dec. 27, 2018

(54) PIXEL DRIVING CIRCUIT AND DRIVING METHOD THEREOF, DISPLAY PANEL AND DISPLAY DEVICE

(71) Applicants: Boe Technology Group Co., Ltd., Beijing (CN); Beijing Boe Optoelectronics Technology Co., Ltd., Beijing (CN)

(72) Inventors: Shengji YANG, Beijing (CN); Xue DONG, Beijing (CN); Hailin XUE, Beijing (CN); Xiaochuan CHEN, Beijing (CN); Haisheng WANG, Beijing (CN); Weijie ZHAO, Beijing (CN); Yingming LIU, Beijing (CN)

(21) Appl. No.: 15/737,255

(22) PCT Filed: Jun. 19, 2017
(86) PCT No.: PCT/CN2017/088938

§ 371 Date: Dec. 15, 2017

(30) Foreign Application Priority Data
Oct. 26, 2016 (CN) 201610945383.9

(51) Int. Cl. G09G 3/3233

(52) U.S. Cl. CPC G09G 3/3233; G09G 2300/0819; G09G 2310/0251; G09G 2300/0871; G09G 2300/0842

(57) ABSTRACT

This disclosure provides a pixel driving circuit, comprising: a driving transistor, a reset sub-circuit, an energy storage sub-circuit, a compensation sub-circuit, a data write sub-circuit and a light emitting sub-circuit. The driving transistor is configured to drive the light emitting sub-circuit to emit light, the reset sub-circuit is configured to reset the energy storage sub-circuit, the energy storage sub-circuit is configured to pre-store a threshold voltage of the driving transistor, the compensation sub-circuit is configured to compensate the threshold voltage of the driving transistor, the data write sub-circuit is configured to write a signal level inputted by the data signal terminal into the third node, and the light emitting sub-circuit is configured to emit light under the driving of the driving transistor. A driving method of the pixel driving circuit and a display panel as well as a display device are further provided.

### RELATED APPLICATION

The present application is the U.S. national phase entry of PCT/CN2017/088938, with an international filing date of Jun. 19, 2017, which claims the priority of the Chinese patent application NO. 201610945383.9 filed on Oct. 26, 2016, the entire disclosure of which is incorporated herein by reference.

### FIELD

This disclosure relates to the field of display technology, particularly to a pixel driving circuit, a display panel comprising the pixel driving circuit, a display device comprising the display panel, and a driving method of the pixel driving circuit.

### BACKGROUND

With the development of the display technology, more and more active matrix organic light emitting diode (AMOLED) display panels come into the market. Compared to the conventional thin film transistor liquid crystal panel (TFT LCD), the active matrix organic light emitting diode display panel has advantages such as low energy consumption, low production cost, self-luminescence, wide visual angle and high response speed. At present, the active matrix organic light emitting diode display panel has begun to replace the conventional LCD display screen gradually in the display fields such as mobile phone, PDA, and digital camera. Different from the TFT LCD which uses a stable voltage to control the luminance, the AMOLED belongs to current driving, which needs a stable current to control light emitting.

### SUMMARY

An object of this disclosure is to provide a pixel driving circuit, a display panel comprising the pixel driving circuit, a display device comprising the display panel, and a driving method of the pixel driving circuit, which can at least partly mitigate or eliminate one or more of the problems in the technologies known to the inventors.

According to a first aspect of this disclosure, a pixel driving circuit is provided, comprising: a driving transistor, a reset sub-circuit, an energy storage sub-circuit, a compensation sub-circuit, a data write sub-circuit and a light emitting sub-circuit. A gate of the driving transistor is connected with a third node, a first terminal of the driving transistor is connected with a first node, a second terminal of the driving transistor is connected with a fourth node, and the driving transistor is configured to drive the light emitting sub-circuit to emit light. The reset sub-circuit is connected with a light emitting control signal terminal, a first scanning signal terminal, a first level terminal, a second level terminal, the first node and a second node, and configured to reset the energy storage sub-circuit. The energy storage sub-circuit is connected with the first node and the second node, and configured to pre-store a threshold voltage of the driving transistor. The compensation sub-circuit is connected with the second node, the third node, the fourth node, the first scanning signal terminal, a second scanning signal terminal and the second level terminal, and configured to compensate the threshold voltage of the driving transistor. The data write sub-circuit is connected with a data signal terminal, the first scanning signal terminal and the third node, and configured to write a signal level inputted by the data signal terminal into the third node. The light emitting sub-circuit is connected with the fourth node and the second level terminal, and configured to emit light under driving of the driving transistor.

In some embodiments, the reset sub-circuit comprises a first transistor and a second transistor. A gate of the first transistor is connected with the light emitting control signal terminal, a first terminal of the first transistor is connected with the first level terminal, and a second terminal of the first transistor is connected with the first node. A gate of the second transistor is connected with the first scanning signal terminal, a first terminal of the second transistor is connected with the second level terminal, and a second terminal of the second transistor is connected with the second node.

In some embodiments, the energy storage sub-circuit comprises an energy storage capacitor. A first polar plate of the energy storage capacitor is connected with the first node, and a second polar plate of the energy storage capacitor is connected with the second node.

In some embodiments, the compensation sub-circuit comprises a third transistor and a fifth transistor. A gate of the third transistor is connected with the second scanning signal terminal, a first terminal of the third transistor is connected with the second node, and a second terminal of the third transistor is connected with the third node. A gate of the fifth transistor is connected with the first scanning signal terminal, a first terminal of the fifth transistor is connected with the fourth node, and a second terminal of the fifth transistor is connected with the second level terminal.

In some embodiments, the data write sub-circuit comprises a fourth transistor. A gate of the fourth transistor is connected with the first scanning signal terminal, a first terminal of the fourth transistor is connected with the data signal terminal, and a second terminal of the fourth transistor is connected with the third node.

In some embodiments, the light emitting sub-circuit comprises an organic light emitting diode. A first terminal of the organic light emitting diode is connected with the fourth node, and a second terminal of the organic light emitting diode is connected with the second level terminal.

In some embodiments, the first transistor, the second transistor, the third transistor, the fourth transistor, the fifth transistor and the driving transistor are P-type transistors. The first terminal is a source, the second terminal is a drain, the first level terminal is a high level terminal, and the second level terminal is a low level terminal.

It should be noted that the transistors used in this disclosure can all be thin film transistors or field effect transistors or other devices with same properties. Since the source and the drain of the transistor used therein are symmetric, the source and the drain thereof are essentially the same. In this disclosure, in order to distinguish the two terminals except for the gate of the transistor, one terminal thereof is called a first terminal, and the other terminal is called a second terminal. In addition, the transistors can be classified into N-type and P-type according to the characteristics of the transistors. When a P-type transistor is used, the first terminal can be a source of the P-type transistor, and the second terminal can be a drain of the P-type transistor. However, as would be understood by the skilled person in the art, one or more of the first transistor, the second transistor, the third transistor, the fourth transistor, the fifth transistor and the driving transistor can also be N-type transistors.

Compared to the pixel driving circuit in the technologies known to the inventors, in the pixel driving circuit provided by an embodiment of this disclosure, a threshold voltage component of the driving transistor is pre-stored in the energy storage sub-circuit. When the driving transistor drives the light emitting sub-circuit to emit light, the threshold voltage component of the driving transistor pre-stored in the energy storage sub-circuit counteracts the threshold voltage component in the current that drives the light emitting sub-circuit, thereby eliminating the influence of the variation of the threshold voltage of the driving transistor in the pixel driving circuit to the light emitting luminance of the light emitting sub-circuit, so as to ensure uniformity of the current that drives the light emitting sub-circuit, thereby ensuring the quality of the display image.

In some embodiments, the second scanning signal terminal is formed by the first scanning signal terminal and a NOT gate.

Since the signal on the first scanning signal terminal is contrary to the signal on the second scanning signal terminal, one scanning signal terminal can be carried out through combination of the other scanning signal terminal and the NOT gate. From the finally obtained display panel, this can reduce the number of the signal lines greatly, reduce the complexity of the wiring, and reduce occupation of the finite wiring space, therefore, it is benefit for miniaturization and lightweight of the display panel.

In some embodiments, the pixel driving circuit comprises a driving transistor, a first transistor, a second transistor, a third transistor, a fourth transistor, a fifth transistor, an energy storage capacitor and an organic light emitting diode. A gate of the driving transistor is connected with a third node, a first terminal of the driving transistor is connected with a first node, and a second terminal of the driving transistor is connected with a fourth node. A gate of the first transistor is connected with a light emitting control signal terminal, a first terminal of the first transistor is connected with a first level terminal, and a second terminal of the first transistor is connected with the first node. A gate of the second transistor is connected with a first scanning signal terminal, a first terminal of the second transistor is connected with a second level terminal, and a second terminal of the second transistor is connected with a second node. A gate of the third transistor is connected with a second scanning signal terminal, a first terminal of the third transistor is connected with the second node, and a second terminal of the third transistor is connected with the third node. A gate of the fourth transistor is connected with the first scanning signal terminal, a first terminal of the fourth transistor is connected with a data signal terminal, and a second terminal of the fourth transistor is connected with the third node. A gate of the fifth transistor is connected with the first scanning signal terminal, a first terminal of the fifth transistor is connected with the fourth node, and a second terminal of the fifth transistor is connected with the second level terminal. A first polar plate of the energy storage capacitor is connected with the first node, and a second polar plate of the energy storage capacitor is connected with the second node. A first terminal of the organic light emitting diode is connected with the fourth node, and a second terminal of the organic light emitting diode is connected with the second level terminal.

According to a second aspect of this disclosure, a display panel is provided, comprising any of the above pixel driving circuits.

According to a third aspect of this disclosure, a display device is provided, comprising the above display panel.

According to a fourth aspect of this disclosure, a method of driving a pixel driving circuit is provided. The pixel driving circuit comprises: a reset sub-circuit, an energy storage sub-circuit, a driving transistor, a compensation sub-circuit, a data write sub-circuit and a light emitting sub-circuit. The reset sub-circuit is connected with a light emitting control signal terminal, a first scanning signal terminal, a first level terminal, a second level terminal, a first node and a second node. The energy storage sub-circuit is connected with the first node and the second node. A gate of the driving transistor is connected with a third node, a first terminal of the driving transistor is connected with the first node, and a second terminal of the driving transistor is connected with a fourth node. The compensation sub-circuit is connected with the second node, the third node, the fourth node, the first scanning signal terminal, a second scanning signal terminal and the second level terminal. The data write sub-circuit is connected with a data signal terminal, the first scanning signal terminal and the third node. The light emitting sub-circuit is connected with the fourth node and the second level terminal. The method comprises: in a reset and charging phase, the reset sub-circuit pulling up a level of the first node to a first level, and pulling down a level of the second node to a second level, the data write sub-circuit writing a signal level inputted by an input signal terminal into the third node; in a discharging phase, the energy storage sub-circuit discharging through the driving transistor and the compensation sub-circuit, so as to enable the level of the first node to be a sum of the signal level inputted by the input signal terminal and a threshold voltage of the driving transistor, and the reset sub-circuit pulling down the level of the second node to the second level; and in a compensating and light emitting phase, the reset sub-circuit pulling up the level of the first node to the first level, the energy storage sub-circuit and the compensation sub-circuit enabling a level of the third node to jump to the first level minus the sum of the signal level inputted by the input signal terminal and the threshold voltage of the driving transistor, and the light emitting sub-circuit emitting light.

Compared to the driving method of a pixel driving circuit in the technologies known to the inventors, in the driving method of a pixel driving circuit provided by an embodiment of this disclosure, a threshold voltage component of the driving transistor is pre-stored in the energy storage sub-circuit in the compensation phase. When the light emitting sub-circuit is driven to emit light in the light emitting phase, the threshold voltage component of the driving transistor pre-stored in the energy storage sub-circuit counteracts the threshold voltage component in the current that drives the light emitting sub-circuit, thereby eliminating the influence of the variation of the threshold voltage of the driving transistor in the pixel driving circuit to the light emitting luminance of the light emitting sub-circuit, so as to ensure uniformity of the current that drives the light emitting sub-circuit, thereby ensuring the quality of the display image.

In some embodiments, the reset sub-circuit comprises a first transistor and a second transistor. A gate of the first transistor is connected with the light emitting control signal terminal, a first terminal of the first transistor is connected with the first level terminal, and a second terminal of the first transistor is connected with the first node. A gate of the second transistor is connected with the first scanning signal terminal, a first terminal of the second transistor is connected with the second level terminal, and a second terminal of the second transistor is connected with the second node. The compensation sub-circuit comprises a third transistor and a fifth transistor. A gate of the third transistor is connected with the second scanning signal terminal, a first terminal of the third transistor is connected with the second node, and a second terminal of the third transistor is connected with the third node. A gate of the fifth transistor is connected with the first scanning signal terminal, a first terminal of the fifth transistor is connected with the fourth node, and a second terminal of the fifth transistor is connected with the second level terminal. The data write sub-circuit comprises a fourth transistor. A gate of the fourth transistor is connected with the first scanning signal terminal, a first terminal of the fourth transistor is connected with the data signal terminal, and a second terminal of the fourth transistor is connected with the third node. In the reset and charging phase, the first transistor, the second transistor, the fourth transistor and the fifth transistor are turned on, and the third transistor is turned off.

In some embodiments, in the discharging phase, the second transistor, the fourth transistor, the fifth transistor and the driving transistor are turned on, and the first transistor and the third transistor are turned off.

In some embodiments, in the compensation and light emitting phase, the first transistor, the third transistor and the driving transistor are turned on, and the second transistor, the fourth transistor and the fifth transistor are turned off.

It should be pointed out that the second, third and fourth aspects of this disclosure have similar or same example implementation and benefits as the first aspect of this disclosure, which will not be repeated here.

These and other aspects of this disclosure will be obvious from the embodiments described below and will be set forth with reference to the embodiments described below.

### BRIEF DESCRIPTION OF DRAWINGS

FIG. 1 schematically illustrates a circuit diagram of a conventional 2T1C pixel driving circuit;

FIG. 2 schematically illustrates a structural block diagram of a pixel driving circuit according to an embodiment of this disclosure;

FIG. 3 schematically illustrates a circuit diagram of a pixel driving circuit according to an embodiment of this disclosure;

FIG. 4 schematically illustrates a circuit diagram of a pixel driving circuit according to another embodiment of this disclosure;

FIG. 5 schematically illustrates a signal timing diagram of a pixel driving circuit as shown in FIG. 3;

FIGS. 6-8 schematically illustrate signal flows at the times as shown in FIG. 5 respectively; and

FIG. 9 schematically illustrates a flow chart of a driving method of a pixel driving circuit according to an embodiment of this disclosure.

### DETAILED DESCRIPTION

Exemplary embodiments of this disclosure will be described in detail in conjunction with the drawings below. The drawings are schematic and are not drawn to scale, moreover, they are only for explaining the embodiments of this disclosure rather than intending to limit the protection scope of this disclosure. In the drawings, the same reference sign represents the same or similar parts. In order to enable the technical solution of this disclosure to be clearer, the process steps and device structures that are well known in the art are omitted here.

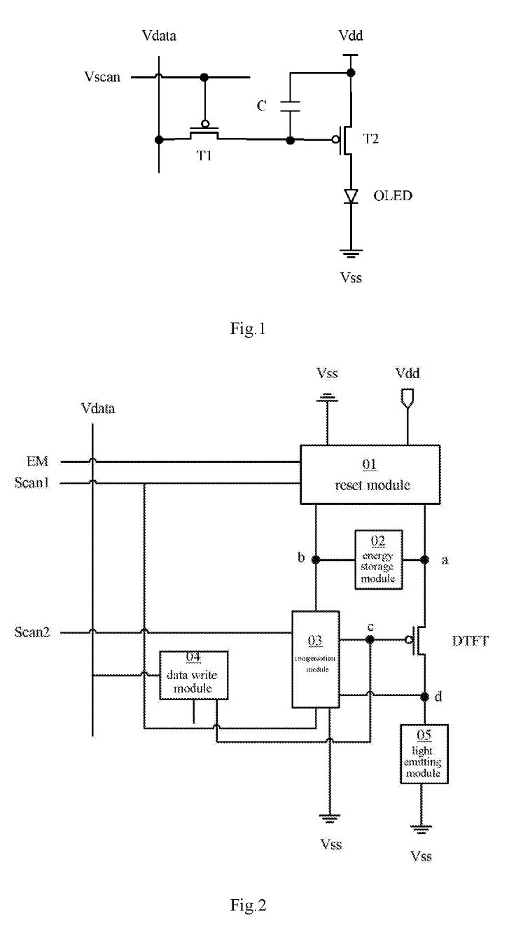

As shown in FIG. 1, an existing pixel driving circuit that drives the OLED to emit light comprises: a switch transistor T1, a driving transistor T2, a storage capacitor C and a light emitting device OLED. A gate of the driving transistor T2 is connected with a drain of the switch transistor T1 and one terminal of the storage capacitor C, a source of the driving transistor T2 is connected with a high voltage signal terminal Vdd and another terminal of the storage capacitor C, and a drain of the driving transistor T2 is connected with one terminal of the light emitting device OLED. A gate of the switch transistor T1 is connected with a scanning signal terminal Vscan, a source of the switch transistor T1 is connected with a data signal terminal Vdata. Another terminal of the light emitting device OLED is connected with a low voltage signal terminal Vss. When the driving transistor T2 drives the light emitting device OLED to emit light, a driving current is controlled by the high voltage signal terminal Vdd, the data signal Vdata and the driving transistor T2 jointly. Take a P-type transistor as an example, when the driving transistor T2 is saturated, the current that flows through the light emitting device OLED is I_{OLED}=K(V_{SG}−Vₜₕ)², wherein K is a constant, V_{SG} is a voltage difference between the source and the gate of the driving transistor T2, Vth is a threshold voltage, which is, for the P-type transistor, a negative value.

In actual use, light emitting luminance of the OLED is quite sensitive to the variation of the driving current thereof. Unfortunately, since the driving transistor T2 cannot be consistent completely in the manufacturing process, and also due to the process and device aging, as well as variation of temperature in the working process etc., the threshold voltage Vth of the driving transistor T2 in each pixel driving circuit is nonuniform, thus it would result in variation of the current that flows through each pixel point OLED, leading to nonuniform display brightness, thereby influencing the display effect of a whole image.

Therefore, how to eliminate the influence of the variation of the threshold voltage of the driving transistor in the pixel driving circuit to the light emitting luminance of the light emitting device, so as to ensure uniformity of the current that drives the light emitting device OLED, thereby ensuring the quality of a display image is a problem to be urgently solved by the skilled person in the art.

FIG. 2 schematically illustrates a structural block diagram of a pixel driving circuit according to an embodiment of this disclosure. As shown in FIG. 2, the pixel driving circuit comprises a reset sub-circuit 01, an energy storage sub-circuit 02, a driving transistor DTFT, a compensation sub-circuit 03, a data write sub-circuit 04 and a light emitting sub-circuit 05. A gate of the driving transistor DTFT is connected with a third node c, a first terminal thereof is connected with a first node a, and a second terminal thereof is connected with a fourth node d. The reset sub-circuit 01 is connected with a light emitting control signal terminal EM, a first scanning signal terminal Scan1, a first level terminal Vdd, a second level terminal Vss, the first node a and a second node b. The energy storage sub-circuit 02 is connected with the first node a and the second node b. The compensation sub-circuit 03 is connected with the second node b, the third node c, the fourth node d, the first scanning signal terminal Scan1, a second scanning signal terminal Scan2 and the second level terminal Vss. The data write sub-circuit 04 is connected with a data signal terminal Vdata, the first scanning signal terminal Scan1 and the third node c. The light emitting sub-circuit 05 is connected with the fourth node d and the second level terminal Vss.

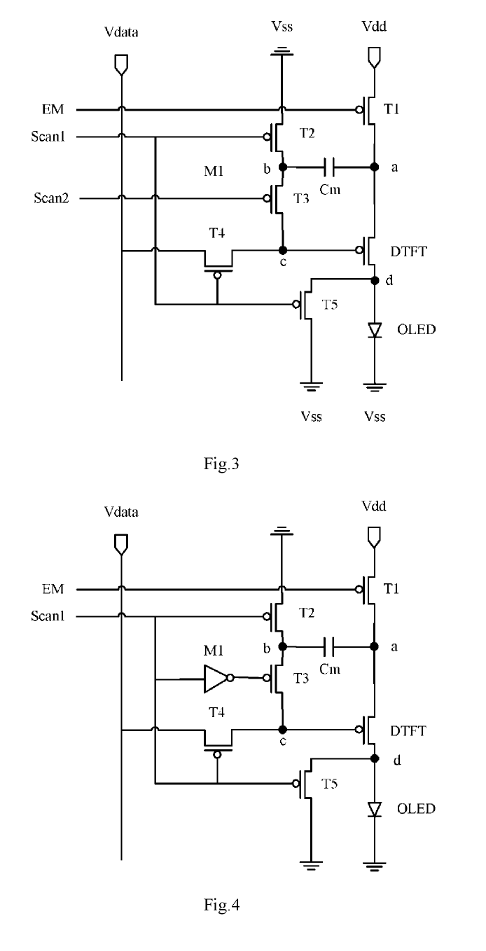

Specifically, as shown in FIG. 3, the reset sub-circuit comprises a first transistor T1 and a second transistor T2. A gate of the first transistor T1 is connected with the light emitting control signal terminal EM, a first terminal thereof is connected with the first level terminal Vdd, and a second terminal thereof is connected with the first node a. A gate of the second transistor T2 is connected with the first scanning signal terminal Scan1, a first terminal thereof is connected with the second level terminal Vss, and a second terminal thereof is connected with the second node b. The energy storage sub-circuit comprises an energy storage capacitor Cm. A first polar plate of the energy storage capacitor Cm is connected with the first node a, and a second polar plate thereof is connected with the second node b. The compensation sub-circuit comprises a third transistor T3 and a fifth transistor T5. A gate of the third transistor T3 is connected with the second scanning signal terminal Scan2, a first terminal thereof is connected with the second node b, and a second terminal thereof is connected with the third node c. A gate of the fifth transistor T5 is connected with the first scanning signal terminal Scan1, a first terminal thereof is connected with the fourth node d, and a second terminal thereof is connected with the second level terminal Vss. The data write sub-circuit comprises a fourth transistor T4. A gate of the fourth transistor T4 is connected with the first scanning signal terminal Scan1, a first terminal thereof is connected with the data signal terminal Vdata, and a second terminal thereof is connected with the third node c. The light emitting sub-circuit comprises an organic light emitting diode OLED. A first terminal of the organic light emitting OLED is connected with the fourth node d, and a second terminal thereof is connected with the second level terminal Vss.

FIG. 4 schematically illustrates a circuit diagram of a pixel driving circuit according to another embodiment of this disclosure. Different from the pixel driving circuit as shown in FIG. 3, in FIG. 4, the second scanning signal terminal is formed by combining the first scanning signal terminal Scan1 with a NOT gate M1. Since the signal on the first scanning signal terminal Scan1 is contrary to the signal on the second scanning signal terminal, the second scanning signal terminal can be carried out through combination of the first scanning signal terminal Scan1 and the NOT gate M1. From the finally obtained display panel, this can reduce the number of the signal lines greatly, reduce the complexity of the wiring, and reduce occupation of the finite wiring space, therefore, it is benefit for miniaturization and lightweight of the display panel.

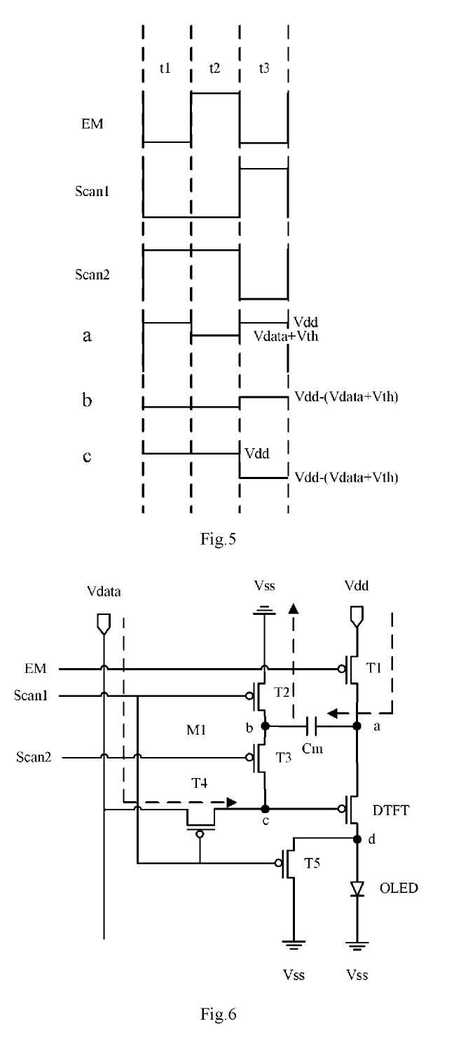

FIG. 5 illustrates a signal timing diagram of the pixel driving circuit as shown in FIG. 3, and FIGS. 6-8 schematically illustrate signal flows at the times as shown in FIG. 5 respectively. In the following description, for example, the first transistor T1, the second transistor T2, the third transistor T3, the fourth transistor T4, the fifth transistor T5 and the driving transistor DTFT are all P-type transistors, the first level terminal Vdd is a high level terminal, and the second level terminal Vss is a low level terminal. However, as would be understood by the skilled person in the art, the pixel driving circuit provided in this disclosure can also use N-type transistors, and in such cases, the first level terminal Vdd is a low level terminal, and the second level terminal Vss is a high level terminal.

At time t1, the first scanning signal terminal Scan1 and the light emitting control signal terminal EM are at low level, and the second scanning signal terminal Scan2 is at high level. Hence, the first transistor T1, the second transistor T2, the fourth transistor T4 and the fifth transistor T5 are turned on, and the third transistor T3 is turned off. The organic light emitting diode OLED does not emit light. At that time, as shown in FIG. 6, the first node a is pulled up by the first transistor T1 to the high level Vdd, the second node b is pulled down by the second transistor T2 to the low level Vss, and the level of the third node c is Vdata due to the turn-on of the fourth transistor T4.

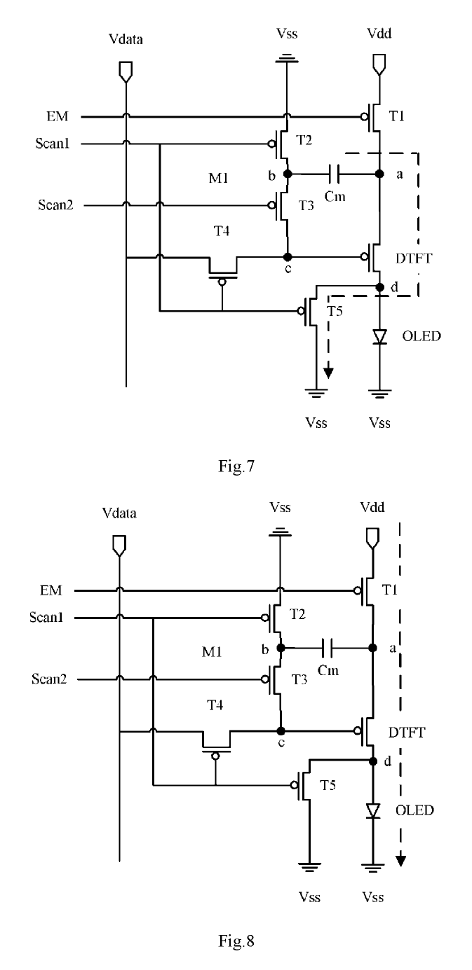

At time t2, the first scanning signal terminal Scan1 is at low level, the second scanning signal terminal Scan2 and the light emitting control signal terminal EM are both at high level. Hence, the second transistor T2, the fourth transistor T4, the fifth transistor T5 and the driving transistor DTFT are tuned on, and the first transistor T1 and the third transistor T3 are turned off. Since the fifth transistor T5 is turned on, the organic light emitting diode OLED is short circuited and does not emit light. Here, as shown in FIG. 7, the energy storage capacitor Cm discharges through the driving transistor DTFT and the fifth transistor T5, so as to enable the level of the first node a to be Vdata+Vth, Vth is a threshold voltage of the driving transistor DTFT. The second node b still remains at low level Vss because the second transistor T2 is turned on. Here, the voltage difference between two polar plates of the energy storage capacitor Cm is Vdata+Vth.

At time t3, the first scanning signal terminal Scan1 is at high level, the second scanning signal terminal Scan2 and light emitting control signal terminal EM are both at low level. Hence, the first transistor T1, the third transistor T3 and the driving transistor DTFT are turned on, and the second transistor T2, the fourth transistor T4 and the fifth transistor T5 are turned off. Since the fifth transistor T5 is turned off and the driving transistor DTFT is turned on, the organic light emitting diode OLED emits light. Here, as shown in FIG. 8, since the first transistor T1 is turned on, the level of the first node a is pulled up to Vdd again, while the second node b is floated because the second transistor T2 is turned off. Since the energy storage capacitor Cm needs to remain the voltage difference Vdata+Vth between two polar plates unchanged, the level of the second node b jumps to (Vdd−(Vdata+Vth)). Because the third transistor T3 is turned on, the level of the third node c is equal to the level of the second node b, i.e., (Vdd−(Vdata+Vth))

At the time t3 when the organic light emitting diode OLED is turned on, according to the saturation current formula of the driving transistor DTFT, the current that flows through the organic light emitting diode OLED is:

I_{OLED}=K(V_{SG}−Vth)²=K[Vdd−(Vdd−(Vdata+Vth))−Vth]²=K·Vdata².

It can be seen that the current that flows through the organic light emitting diode OLED is not influenced by the threshold voltage Vth of the driving transistor DTFT, hence, the pixel driving circuit in the embodiment of this disclosure thoroughly eliminates the influence of the variation of the threshold voltage of the driving transistor in the pixel driving circuit to the light emitting luminance of the light emitting sub-circuit, so as to ensure uniformity of the current that drives the light emitting sub-circuit, thereby ensuring the quality of the display image.

An embodiment of this disclosure provides a display panel, comprising the above pixel driving circuit provided by an embodiment of this disclosure.

An embodiment of this disclosure further provides a display device, comprising the above display panel provided by an embodiment of this disclosure. The display device can be any product or component with the display function such as a mobile phone, a panel computer, a television, a display, a notebook, a digital photo frame, a navigator etc.

Compared to the display panel and the display device of the technologies known to the inventors, in this disclosure, a threshold voltage component of the driving transistor is pre-stored in the energy storage sub-circuit. When the driving transistor drives the light emitting sub-circuit to emit light, the threshold voltage component of the driving transistor pre-stored in the energy storage sub-circuit counteracts the threshold voltage component in the current that drives the light emitting sub-circuit, thereby eliminating the influence of the variation of the threshold voltage of the driving transistor in the pixel driving circuit to the light emitting luminance of the light emitting sub-circuit, so as to ensure uniformity of the current that drives the light emitting sub-circuit, thereby ensuring the quality of the display image.

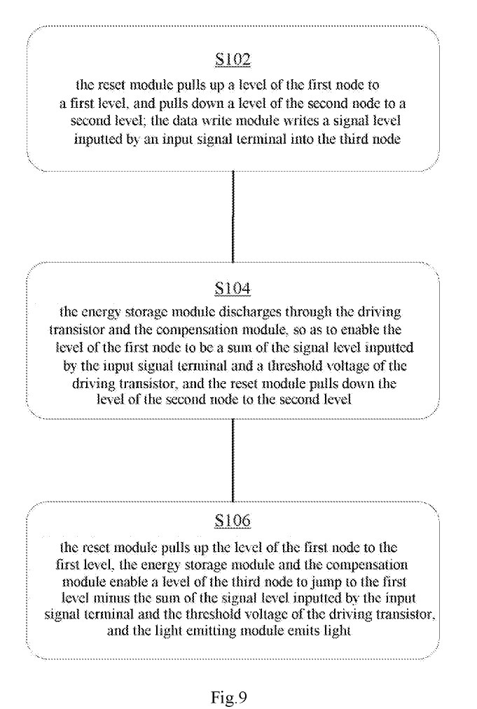

FIG. 9 schematically illustrates a flow chart of a driving method of a pixel driving circuit according to an embodiment of this disclosure. Referring to FIG. 2, the pixel driving circuit comprises: a reset sub-circuit, an energy storage sub-circuit, a driving transistor, a compensation sub-circuit, a data write sub-circuit and a light emitting sub-circuit. The reset sub-circuit is connected with a light emitting control signal terminal, a first scanning signal terminal, a first level terminal, a second level terminal, a first node and a second node. The energy storage sub-circuit is connected with the first node and the second node. A gate of the driving transistor is connected with a third node, a first terminal of the driving transistor is connected with the first node, and a second terminal of the driving transistor is connected with a fourth node. The compensation sub-circuit is connected with the second node, the third node, the fourth node, the first scanning signal terminal, a second scanning signal terminal and the second level terminal. The data write sub-circuit is connected with a data signal terminal, the first scanning signal terminal and the third node. The light emitting sub-circuit is connected with the fourth node and the second level terminal. The driving method comprises: a reset and charging phase, a discharging phase and a compensation and light emitting phase. In the reset and charging phase S102, the reset sub-circuit pulls up a level of the first node to a first level, and pulls down a level of the second node to a second level, the data write sub-circuit writes a signal level inputted by an input signal terminal into the third node. In the discharging phase S104, the energy storage sub-circuit discharges through the driving transistor and the compensation sub-circuit, so as to enable the level of the first node to be a sum of the signal level inputted by the input signal terminal and a threshold voltage of the driving transistor, and the reset sub-circuit pulls down the level of the second node to the second level. In the compensating and light emitting phase S106, the reset sub-circuit pulls up the level of the first node to the first level, the energy storage sub-circuit and the compensation sub-circuit enable a level of the third node to jump to the first level minus the sum of the signal level inputted by the input signal terminal and the threshold voltage of the driving transistor, and the light emitting sub-circuit emits light.

Referring to the circuit diagram as shown in FIG. 3 and the signal timing diagram as shown in FIG. 5, in the reset and charging phase (time t1), the first transistor, the second transistor, the fourth transistor and the fifth transistor are turned on, and the third transistor is turned off. In the discharging phase (time t2), the second transistor, the fourth transistor, the fifth transistor and the driving transistor are turned on, and the first transistor and the third transistor are turned off. In the compensation and light emitting phase (time t3), the first transistor, the third transistor and the driving transistor are turned on, and the second transistor, the fourth transistor and the fifth transistor are turned off.

Compared to the driving method of the pixel driving circuit in the technologies known to the inventors, in the driving method of the pixel driving circuit provided by an embodiment of this disclosure, a threshold voltage component of the driving transistor is pre-stored in the energy storage sub-circuit in the compensation phase. When the light emitting sub-circuit is driven to emit light in the light emitting phase, the threshold voltage component of the driving transistor pre-stored in the energy storage sub-circuit counteracts the threshold voltage component in the current that drives the light emitting sub-circuit, thereby eliminating the influence of the variation of the threshold voltage of the driving transistor in the pixel driving circuit to the light emitting luminance of the light emitting sub-circuit, so as to ensure uniformity of the current that drives the light emitting sub-circuit, thereby ensuring the quality of the display image.

It should be noted that although the driving method of the pixel driving circuit is divided into three phases in FIG. 9, this is only for simple and convenient description. Moreover, although the driving method of the pixel driving circuit is shown in a flow chart, the driving method is not limited to the illustrated order. In fact, the driving method in FIG. 9 can be divided into several phases as appropriate, and different phases can be staggered and merged in time without departing from the spirit and the scope of this disclosure.

Although several embodiments have been described in detail above, other modifications are also possible. For example, the flow chart described above does not require the particular sequence or order described to achieve the desired result. Other steps can be provided, or steps can be removed from the described flow chart. Moreover, other component can be added into or removed from the described system. Other embodiments can be within the scope of this disclosure. The skilled person in the art, in view of the teaching of this disclosure, can achieve numerous variants and modifications without departing from the spirit and the scope of this disclosure.

1. A pixel driving circuit, comprising: a driving transistor, a reset sub-circuit, an energy storage sub-circuit, a compensation sub-circuit, a data write sub-circuit and a light emitting sub-circuit, wherein
a gate of the driving transistor is connected with a third node, a first terminal of the driving transistor is connected with a first node, a second terminal of the driving transistor is connected with a fourth node, the driving transistor configured to drive the light emitting sub-circuit to emit light;
the reset sub-circuit is connected with a light emitting control signal terminal, a first scanning signal terminal, a first level terminal, a second level terminal, the first node and a second node, and configured to reset the energy storage sub-circuit;
the energy storage sub-circuit is connected with the first node and the second node, and configured to pre-store a threshold voltage of the driving transistor;
the compensation sub-circuit is connected with the second node, the third node, the fourth node, the first scanning signal terminal, a second scanning signal terminal and the second level terminal, and configured to compensate the threshold voltage of the driving transistor;
the data write sub-circuit is connected with a data signal terminal, the first scanning signal terminal and the third node, and configured to write a signal inputted by the data signal terminal into the third node; and
the light emitting sub-circuit is connected with the fourth node and the second level terminal, and configured to emit light under driving of the driving transistor.

2. The pixel driving circuit as claimed in claim 1, wherein the reset sub-circuit comprises a first transistor and a second transistor, wherein a gate of the first transistor is connected with the light emitting control signal terminal, a first terminal of the first transistor is connected with the first level terminal, and a second terminal of the first transistor is connected with the first node; a gate of the second transistor is connected with the first scanning signal terminal, a first terminal of the second transistor is connected with the second level terminal, and a second terminal of the second transistor is connected with the second node.

3. The pixel driving circuit as claimed in claim 1, wherein the energy storage sub-circuit comprises an energy storage capacitor, wherein a first polar plate of the energy storage capacitor is connected with the first node, and a second polar plate of the energy storage capacitor is connected with the second node.

4. The pixel driving circuit as claim in claim 1, wherein the compensation sub-circuit comprises a third transistor and a fifth transistor, wherein a gate of the third transistor is connected with the second scanning signal terminal, a first terminal of the third transistor is connected with the second node, and a second terminal of the third transistor is connected with the third node, a gate of the fifth transistor is connected with the first scanning signal terminal, a first terminal of the fifth transistor is connected with the fourth node, and a second terminal of the fifth transistor is connected with the second level terminal.

5. The pixel driving circuit as claim in claim 1, wherein the data write sub-circuit comprises a fourth transistor, wherein a gate of the fourth transistor is connected with the first scanning signal terminal, a first terminal of the fourth transistor is connected with the data signal terminal, and a second terminal of the fourth transistor is connected with the third node.

6. The pixel driving circuit as claim in claim 1, wherein the light emitting sub-circuit comprises an organic light emitting diode, wherein a first terminal of the organic light emitting diode is connected with the fourth node, a second terminal of the organic light emitting diode is connected with the second level terminal.

7. The pixel driving circuit as claimed in claim 1, wherein the driving transistors is a P-type transistor, wherein the first terminal is a source, the second terminal is a drain, the first level terminal is a high level terminal, and the second level terminal is a low level terminal.

8. The pixel driving circuit as claimed in claim 1, wherein the second canning signal terminal is formed by combining the first scanning signal terminal with a NOT gate.

9. The pixel driving circuit as claimed in claim 1, wherein,
the reset sub-circuit comprises a first transistor and a second transistor, wherein a gate of the first transistor is connected with the light emitting control signal terminal, a first terminal of the first transistor is connected with the first level terminal, and a second terminal of the first transistor is connected with the first node; a gate of the second transistor is connected with the first scanning signal terminal, a first terminal of the second transistor is connected with the second level terminal, and a second terminal of the second transistor is connected with the second node;
the energy storage sub-circuit comprises an energy storage capacitor, wherein a first polar plate of the energy storage capacitor is connected with the first node, and a second polar plate of the energy storage capacitor is connected with the second node;
the compensation sub-circuit comprises a third transistor and a fifth transistor, wherein a gate of the third transistor is connected with the second scanning signal terminal, a first terminal of the third transistor is connected with the second node, and a second terminal of the third transistor is connected with the third node, a gate of the fifth transistor is connected with the first scanning signal terminal, a first terminal of the fifth transistor is connected with the fourth node, and a second terminal of the fifth transistor is connected with the second level terminal;
the data write sub-circuit comprises a fourth transistor, wherein a gate of the fourth transistor is connected with the first scanning signal terminal, a first terminal of the fourth transistor is connected with the data signal terminal, and a second terminal of the fourth transistor is connected with the third node;
the light emitting sub-circuit comprises an organic light emitting diode, wherein a first terminal of the organic light emitting diode is connected with the fourth node, a second terminal of the organic light emitting diode is connected with the second level terminal.

10. A pixel driving circuit, comprising: a driving transistor, a first transistor, a second transistor, a third transistor, a fourth transistor, a fifth transistor, an energy storage capacitor and an organic light emitting diode,
wherein,
a gate of the driving transistor is connected with a third node, a first terminal of the driving transistor is connected with a first node, and a second terminal of the driving transistor is connected with a fourth node;
a gate of the first transistor is connected with a light emitting control signal terminal, a first terminal of the first transistor is connected with a first level terminal, and a second terminal of the first transistor is connected with the first node;
a gate of the second transistor is connected with a first scanning signal terminal, a first terminal of the second transistor is connected with a second level terminal, and a second terminal of the second transistor is connected with a second node;
a gate of the third transistor is connected with a second scanning signal terminal, a first terminal of the third transistor is connected with the second node, and a second terminal of the third transistor is connected with the third node;
a gate of the fourth transistor is connected with the first scanning signal terminal, a first terminal of the fourth transistor is connected with a data signal terminal, and a second terminal of the fourth transistor is connected with the third node;
a gate of the fifth transistor is connected with the first scanning signal terminal, a first terminal of the fifth transistor is connected with the fourth node, and a second terminal of the fifth transistor is connected with the second level terminal;
a first polar plate of the energy storage capacitor is connected with the first node, and a second polar plate of the energy storage capacitor is connected with the second node; and
a first terminal of the organic light emitting diode is connected with the fourth node, and a second terminal of the organic light emitting diode is connected with the second level terminal.

11. A display panel, comprising the pixel driving circuit as claimed in claim 1.

12. A display device, comprising the display panel as claimed in claim 11.

13. A driving method of a pixel driving circuit, wherein the pixel driving circuit comprises: a reset sub-circuit, an energy storage sub-circuit, a driving transistor, a compensation sub-circuit, a data write sub-circuit and a light emitting sub-circuit, wherein the reset sub-circuit is connected with a light emitting control signal terminal, a first scanning signal terminal, a first level terminal, a second level terminal, a first node and a second node; the energy storage sub-circuit is connected with the first node and the second node; a gate of the driving transistor is connected with a third node, a first terminal of the driving transistor is connected with the first node, and a second terminal of the driving transistor is connected with a fourth node; the compensation sub-circuit is connected with the second node, the third node, the fourth node, the first scanning signal terminal, a second scanning signal terminal and the second level terminal; the data write sub-circuit is connected with a data signal terminal, the first scanning signal terminal and the third node; the light emitting sub-circuit is connected with the fourth node and the second level terminal,
wherein the method comprises:
in a reset and charging phase, the reset sub-circuit pulling up a level of the first node to a first level, and pulling down a level of the second node to a second level, and the data write sub-circuit writing a signal level inputted by an input signal terminal into the third node;
in a discharging phase, the energy storage sub-circuit discharging through the driving transistor and the compensation sub-circuit, so as to enable the level of the first node to be a sum of the signal level inputted by the input signal terminal and a threshold voltage of the driving transistor, and the reset sub-circuit pulling down the level of the second node to the second level; and
in a compensating and light emitting phase, the reset sub-circuit pulling up the level of the first node to the first level, the energy storage sub-circuit and the compensation sub-circuit enabling a level of the third node to jump to the first level minus the sum of the signal level inputted by the input signal terminal and the threshold voltage of the driving transistor, and the light emitting sub-circuit emitting light.

14. The method as claimed in claim 13, wherein,
the reset sub-circuit comprises a first transistor and a second transistor, wherein a gate of the first transistor is connected with the light emitting control signal terminal, a first terminal of the first transistor is connected with the first level terminal, and a second terminal of the first transistor is connected with the first node; a gate of the second transistor is connected with the first scanning signal terminal, a first terminal of the second transistor is connected with the second level terminal, and a second terminal of the second transistor is connected with the second node;
the compensation sub-circuit comprises a third transistor and a fifth transistor, wherein a gate of the third transistor is connected with the second scanning signal terminal, a first terminal of the third transistor is connected with the second node, and a second terminal of the third transistor is connected with the third node, a gate of the fifth transistor is connected with the first scanning signal terminal, a first terminal of the fifth transistor is connected with the fourth node, and a second terminal of the fifth transistor is connected with the second level terminal;
the data write sub-circuit comprises a fourth transistor, wherein a gate of the fourth transistor is connected with the first scanning signal terminal, a first terminal of the fourth transistor is connected with the data signal terminal, and a second terminal of the fourth transistor is connected with the third node,
wherein,
in the reset and charging phase, the first transistor, the second transistor, the fourth transistor and the fifth transistor are turned on, and the third transistor is turned off.

15. The method as claimed in claim 14, wherein in the discharging phase, the second transistor, the fourth transistor, the fifth transistor and the driving transistor are turned on, and the first transistor and the third transistor are turned off.

16. The method as claimed in claim 14, wherein in the compensation and light emitting phase, the first transistor, the third transistor and the driving transistor are turned on, and the second transistor, the fourth transistor and the fifth transistor are turned off.

17. The pixel driving circuit as claimed in claim 2, wherein the first transistor and the second transistor are P-type transistors, wherein the first terminal is a source, the second terminal is a drain, the first level terminal is a high level terminal, and the second level terminal is a low level terminal.

18. The pixel driving circuit as claimed in claim 3, wherein the driving transistors is a P-type transistor, wherein the first terminal is a source, the second terminal is a drain, the first level terminal is a high level terminal, and the second level terminal is a low level terminal.

19. The pixel driving circuit as claimed in claim 4, wherein the third transistor and the fifth transistor are P-type transistors, wherein the first terminal is a source, the second terminal is a drain, the first level terminal is a high level terminal, and the second level terminal is a low level terminal.

20. The pixel driving circuit as claimed in claim 5, wherein the fourth transistors is a P-type transistor, wherein the first terminal is a source, the second terminal is a drain, the first level terminal is a high level terminal, and the second level terminal is a low level terminal.
